(19) United States
(12) Patent Application Publication
(10) Pub. No.: US 2009/0155681 A1
(43) Pub. Date: Jun. 18, 2009

(54) Structure of a battery set

(75) Inventors: Shang-Chih Lin, Hukou Township (TW); Shu-Chen Ho, Hukou Township (TW); I-Hung Hsiao, Hukou Township (TW); Tsung-Shih Huang, Hukou Township (TW)

Correspondence Address: Joe McKinney Muncy, PO Box 1364, Fairfax, VA, 22038-1364, US

(73) Assignee: SIMPLO TECHNOLOGY CO., LTD.

(21) Appl. No.: 12/071,238

(22) Filed: Feb. 19, 2008

(30) Foreign Application Priority Data
Dec. 13, 2007 (TW) 96221256

(51) Int. Cl. H01M 2/02

(52) U.S. Cl. 429/163; 429/122

(57) ABSTRACT

The present invention provides a structure of a battery set including a battery body and a holder. The battery body has a circuit board disposed on a side of the battery body. The circuit board has a plurality of conductive pads. The holder with “U” shaped profile is provided on the side of the battery body with the circuit board and keeps a vacancy against the battery body. The filling body is formed in the vacancy between the battery body and the holder to envelop the circuit board and secure the connection of the holder and the battery body.

### RELATED APPLICATIONS

This application claims priority to Taiwan Application Serial Number 96221256, filed Dec. 13, 2007, which is herein incorporated by reference.

### BACKGROUND

1. Field of Invention

This invention is related to a battery set, and more particularly to a battery set with filling body formed by insert injection molding.

2. Description of Related Art

A booming electronics industry and the rapid development of the mobile electronics market for multifunctional compact portable communication devices have made efficient battery units a priority. Portable communication devices are popular and commonly accepted by people because of convenience and efficiency. These portable communication devices with powerful functions may consume a lot of electricity, thus, the price, power capacity, and secure packaging issue of a battery set for the portable communication device might be purchase considerations to customers. If the package of the battery set is not sealed securely and firmly enough, short circuits or chemical substance spillage may occur to further damage battery cells or the circuit board after colliding.

To solve the above-mentioned problems, generally, vendors will add a hard outer case (e.g. metal case) to protect the battery cell and the circuit board with respect to the whole structure. However, this may increase the material cost and the size of the battery set. In conclusion, the above structure of the battery set package must be improved.

### SUMMARY

It is therefore an objective of the present invention to present a structure of a battery set in order to shrink the battery set in size, strengthen intensity and security in structure, and save cost from adding the outer case.

To achieve the foregoing objectives, the present invention provides a structure of a battery set including a battery body and a holder. The battery body has a circuit board disposed on a side of the battery body. The circuit board has a plurality of conductive pads. The holder is provided on the side of the battery body with the circuit board and keeps a vacancy against the battery body. The filling body is provided in the vacancy between the holder and the battery body. The filling body also envelops the circuit board and secures the connection of the holder and the battery body.

In an embodiment of the present invention, the battery body has a pair of conductive plates disposed on two opposite sides thereof and the circuit board is disposed on another side near the sides with the conductive plates. The holder having a “U” shaped profile is disposed on the side of the battery body with the circuit board in which each of the two opposite sides of the holder respectively faces one of the two opposite sides of the battery body with the conductive plate and covers the conductive plate thereon. The filling body is formed by insert injection molding in a vacancy between the holder and the battery body and envelops the circuit board and the conductive plates, and secures the connection of the holder and the battery body.

To sum up, the present invention strongly protects the circuit board and the conductive plates inside the battery set by injecting the filling body characterized as a cushion to absorb pressure from external force and a waterproof barrier to shield the cells and the circuit board from water damage. Furthermore, parts of the filling body provided between each of the opposite sides of the holder and the battery body enhances the holder adhering to the battery body and prevents the holder from being easily detached from the battery body as the battery set collides with something or somewhere.

### BRIEF DESCRIPTION OF THE DRAWINGS

The structure and the technical means adopted by the present invention to achieve the above and other objects can be best understood by referring to the following detailed description of the preferred embodiments and the accompanying drawings, where:

FIG. 1 is an exploded view of a battery set according to the present invention;

FIG. 2a is a perspective view of a holder assembled on a battery body according to the present invention;

FIG. 2b is a perspective view of a filling body filled between the holder and the battery body according to the present invention;

FIG. 3 is a flowchart according to a manufacturing process of the battery set according to the present invention;

### DESCRIPTION OF THE PREFERRED EMBODIMENTS

It is to be understood that the following disclosure provides one or more preferred embodiment, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

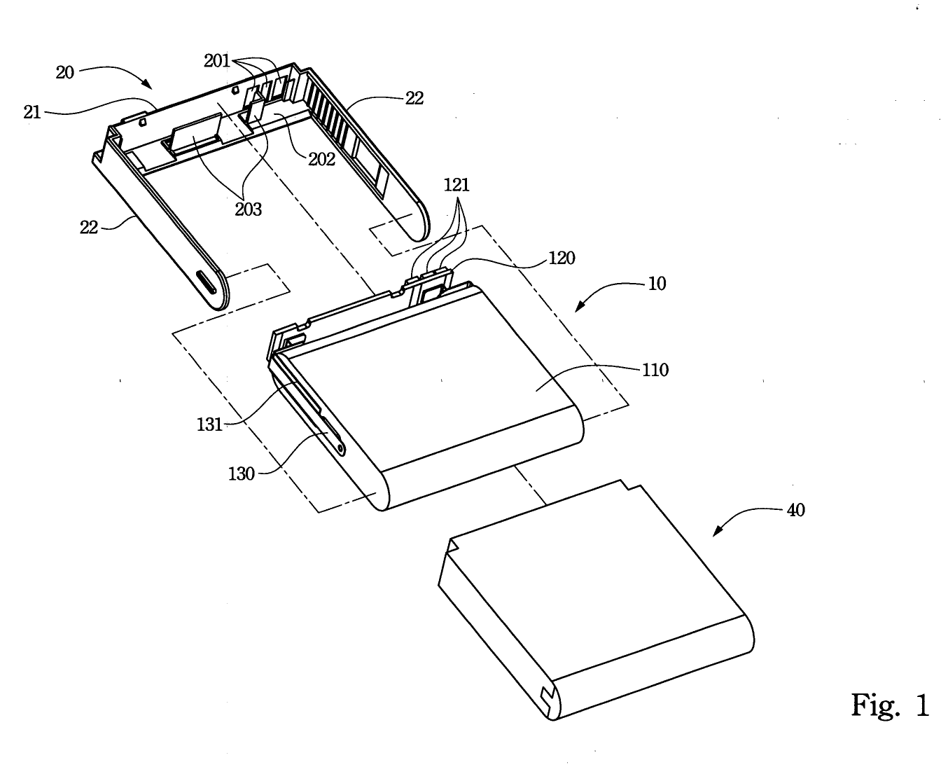

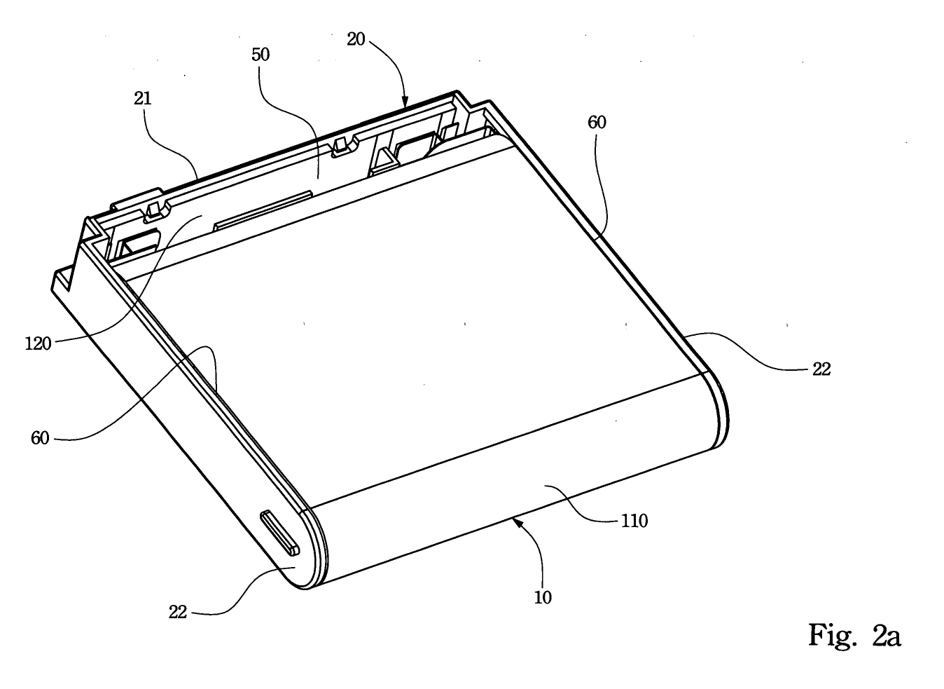

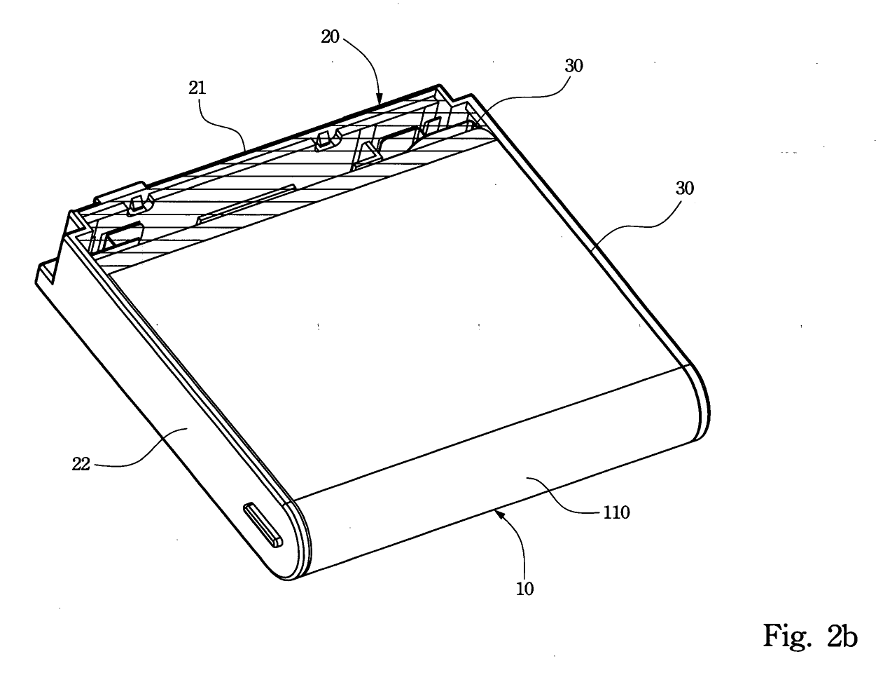

Simultaneously referring to FIG. 1, FIG. 2a and FIG. 2b. FIG. 1 is an exploded view of a battery set according to the present invention, FIG. 2a is a perspective view of a holder assembled on a battery body according to the present invention, and FIG. 2b is a perspective view of a filling body filled between the holder and the battery body according to the present invention. The present invention provides to a structure of a battery set which is usually adopted on a portable electronic device, such as a camcorder, a mobile phone, a personal digital assistant (PDA) and the like. The battery set at least comprises a battery body 10, a holder 20, a filling body 30 and a packing body 40.

In an embodiment, the battery body 10 can be seen as a generic of a battery cell 110 with a circuit board 120 electrically connected with the battery cell 110. The battery cell 110 has a positive electrode disposed on one side thereof and a negative electrode disposed on the other side thereof which is opposite to the positive electrode. The circuit board 120 is disposed on another side near the sides having the two electrodes, has a plurality of conductive pads 121 which transmit electric current outwardly against the battery cell 110. There is also a separation gap between the circuit board 120 and the battery cell 110 to avoid short circuits when the circuit board 120 touches the battery cell 110. The circuit board 120 is electrically connected to the positive electrode and the negative electrode with a conductive plate 130 (e.g. Ni-plate) separately. So that the positive electrode and the negative electrode of the battery cell 110 cooperatively output electric current to the circuit board 120 via the contacts with the conductive plates 130. Accordingly, the circuit board 120 then transmits the output of the electric current to the portable electronic device via these conductive pads 121.

To avoid the occurrence of the short circuit, two isolating plates 131 are respectively placed between the battery cell 110 and the conductive plates 130 in case.

In this embodiment, the holder 20 at least comprises a plate body 21 and two arm bodies 22. The holder 20 is disposed on the side of the battery body 10 with the circuit board 120 in which two arm bodies 22 of the holder 20 respectively face each of the two opposite sides of the battery body 10 with the conductive plate 130 and cover the conductive plate 130 thereon. Each arm body respectively extends towards the battery body 10 from each of two ends of the plate body 21. Thus, the holder 20 presents as a “U” shaped profile. The plate body 21 facing the circuit board 120 has a plurality of openings 201 in which each of the openings 201 just corresponds and fits to one of the conductive pads 121 of the circuit board 120 and a flange 202 extends towards the battery body 10 from an edge of the holder 20, wherein the flange 202 has at least a rib 203 thereon for holding the circuit board 120 on the flange 202.

Therefore, the holder 20 can be assembled on the side of the battery body 10 with the circuit board 120, and then the circuit board 120 is held on the flange 202 with the rib 203, so that the plate body 21 is facing the circuit board 120 and separately discloses these conductive pads 121 by the corresponding openings 201, and each of the arm bodies 22 respectively faces one of the two opposite sides of the battery body 10 with the conductive plate 130 and covers the conductive plate 130 thereon.

Since there is vacancy between the holder 20 and the battery body 10, for easily introducing below, we hereby respectively name a part of the vacancy between the plate body 21 and the battery cell 110 as a space 50, and other part of the vacancy between each of the arm bodies 22 and the side of the battery cell 110 with the conductive plate 130 as a seam 60.

The filling body 30 is completely formed in both the space 50 and the seams 60, which are defined above by the insert injection molding, and the filling body 30 envelops both the circuit board 120 and the conductive plates 130 to strongly protect the circuit board 120 and the conductive plates 130 from collisions by external forces and penetration through water. Furthermore, the filling body 30 in each seam 60 can enhance the holder 20 adhering to the battery body 10 and prevent the holder 20 from easily coming off the battery body 10 due to the collision.

The packing body 40 is disposed on the outer surface of the battery body 10, at least covers a part of the battery body 10 and the filling body 30, and provides a supplemental protection to the battery body 10. The packing body 40 is also marked the manufacturing location and security test information in compliance with this battery set product.

In this embodiment, the packing body 40 can be a plastic covering (e.g. foil label) or a paster (e.g. sticking paper label).

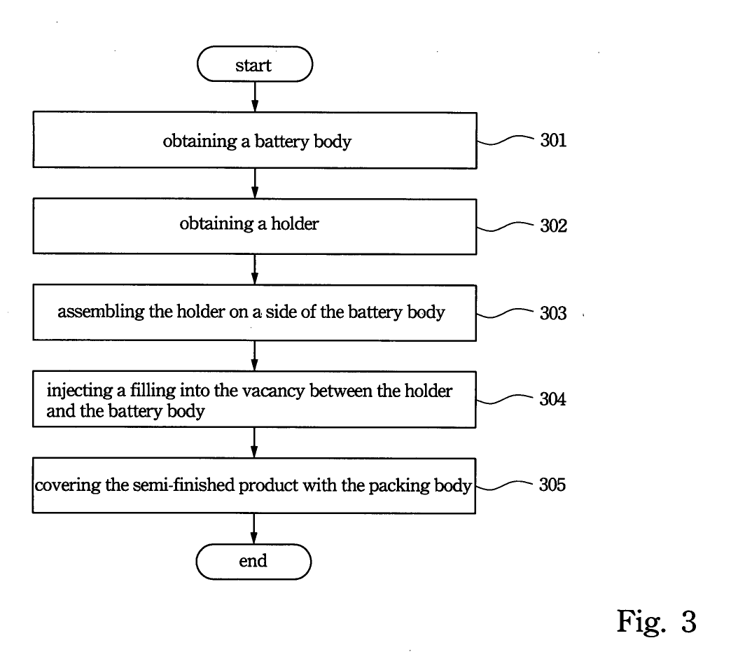

FIG. 3 is a flowchart according to a manufacturing process of the battery set regarding the present invention, including as listed below:

Step (301) obtaining a battery body 10:

First a battery cell 110, a circuit board 120, two conductive plates 130 and two isolating plates 131 as mentioned above are prepared and assembled into a battery body 10 according to the foregoing description.

Step (302) obtaining a holder 20:

With this step, the holder 20 is made of plastic material via the insert injection molding.

Step (303) assembling the holder 20 on a side of the battery body 10:

With this step, the holder 20 on a side of the battery body 10 is assembled with the circuit board 120. Thus, each of the two arm bodies 22 of the holder 20 faces one of the two opposite sides of the battery body 10 with the conductive plate 130, and respectively covers the conductive plate 130 thereon.

Step (304) injecting the filling (e.g. plastic material) into the vacancy between the holder 20 and the battery body 10:

The details of sub-steps of this step are as follows:

(i) Putting the battery body 10 assembled with the circuit board 120 into a mold for insert injection molding;

(ii) Aiming a feeder at the space 50 between the plate body 21 and the battery cell 110;

(iii) Injecting the filling into the space 50 between the plate body 21 and the battery cell 110, wherein two branches provided with accompanying the plastic material are divided and flow towards each seam 60 between the arm bodies 22 and the side of the battery cell 110 with the conductive plate 130 after the filling fills into the space 50, and eventually, the filling in the vacancy between the holder 20 and the battery body 10 will be completely full;

(iv) Cooling the filling in the vacancy between the holder 20 and the battery body 10 to finally form the so-called “filling body 30”, wherein the circuit board 120 is enveloped in somewhere of the filling body 30 in the space 50 and the conductive plates 130 are respectively enveloped in the seams 60 of the filling body 30; and

(v) Separating the mold from the semi-finished product which comprises the battery body 10 with the circuit board 120 and the filling body 30, thus the step (304) is done.

Step (305) covering the semi-finished product with the packing body 40:

The last step is to cover an outer surface of the semi-finished product with a plastic covering or a paster mentioned above, so that the circuit board 120 and the conductive plates 130 will not be disclosed after the filling body 30 was damaged.

Finally, the present invention of the structure of the battery set protects the circuit board 120 and the conductive plates 130 from collision due to external forces and water. Furthermore, the manufacturing process is easy to increases the assembly efficiency.

Furthermore, the filling body 30 provided between each of the opposite sides of the holder 20 and the battery body 10 enhances the adherence of the holder 20 on the battery body 10 and prevents the holder 20 from being easily separated from the battery body 10 with collisions.

Although the present invention has been described in considerable detail with reference in the certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without parting from the scope or spirit of the invention. In view of the foregoing, it is intended that the present invention cover modifications and variations of this invention provided they fall within the scope of the following claims and their equivalents.

What is claimed is:

1. A structure of a battery set, the battery set comprising:
a battery body having a circuit board disposed on a side of the battery body, wherein the circuit board has a plurality of conductive pads;
a holder disposed on the side of the battery body with the circuit board and keeping a vacancy against the battery body; and
a filling body provided in the vacancy between the holder and the battery body to envelop the circuit board and secure the connection of the holder and the battery body.

2. The structure of the battery set as claimed in claim 1, wherein the holder has a plurality of openings in which each corresponds to and fits one of the conductive pads; and a flange extends towards the battery body from an edge of the holder and has at least a rib for holding the circuit board on the flange.

3. The structure of the battery set as claimed in claim 2, wherein the filling body is fully filled in the vacancy by insert injection molding.

4. The structure of the battery set as claimed in claim 1 further comprises a packing body covering the battery body and the filling body.

5. The structure of the battery set as claimed in claim 4, wherein the packing body is a plastic covering or a paster.

6. A structure of a battery set, the battery set comprising:
a battery body having a pair of conductive plates disposed on two opposite sides thereof and a circuit board disposed on another side near the sides with the conductive plates, wherein the circuit board has a plurality of conductive pads;
a holder having a “U” shaped profile, and disposed on the another side of the battery body with the circuit board, wherein each of two opposite sides of the holder respectively faces one of the two opposite sides of the battery body with the conductive plate and covers the conductive plate thereon; and
a filling body provided in a vacancy between the holder and the battery body to envelop the circuit board and the conductive plates, and secure the connection of the holder and the battery body.

7. The structure of the battery set as claimed in claim 6, wherein the holder further comprises:
a plate body facing the circuit board and having a plurality of openings in which each corresponds to and fits one of the conductive pads on the circuit board;
a flange extending towards the battery body from an edge of the holder and having at least a rib thereon for holding the circuit board on the flange; and
two arm bodies respectively extending towards the battery body from one of two ends of the plate body, wherein each of the arm bodies respectively faces one of the two sides of the battery body with the conductive plate, and covers the conductive plate thereon.

8. The structure of the battery set as claimed in claim 7, wherein the filling body is formed in the vacancy between the plate body and the battery body by insert injection molding.

9. The structure of the battery set as claimed in claim 8, wherein the filling body is formed in the vacancy between the two arm bodies and the battery body by insert injection molding.

10. The structure of the battery set as claimed in claim 6 further comprises a packing body covering the battery body and the filling body.

11. The structure of the battery set as claimed in claim 10, wherein the packing body is a plastic covering or a paster.
